(19) United States
(12) Patent Application Publication
(10) Pub. No.: US 2015/0081381 A1
(43) Pub. Date: Mar. 19, 2015

(54) SYSTEM AND METHOD FOR RECORDING TIME

(71) Applicant: Chukwudumebi OKOBA, Largo, MD (US)

(72) Inventor: Chukwudumebi OKOBA, Largo, MD (US)

(21) Appl. No.: 14/221,728

(22) Filed: Mar. 21, 2014

Related U.S. Application Data
(60) Provisional application No. 61/879,714, filed on Sep. 19, 2013.
(60) Provisional application No. 61/883,533, filed on Sep. 27, 2013.

(51) Int. Cl. G06Q 30/02

(52) U.S. Cl. CPC G06Q 30/0255; G06Q 30/0201
USPC 705/7.29; 705/14.53

(57) ABSTRACT

A system and method for recording time. The system may consist of a software extension. The extension may record the time a user is on a device, software, or application. The user may use the extension to redeem vouchers or trade with other members of the community. The method may consist of a user logging into a plugin or extension. The extension may record a user's activity, including time spent on the device, software, or application. The time recorded may then be exchanged for vouchers, which the user may redeem or trade with other members.

### BACKGROUND

Technology consumes a large part of the average person's day. Many businesses interact with their customer base through technology. In fact, the value of many businesses is derived from the amount of consumer interaction they achieve through technology and the internet. Some users spend a great deal of time interacting in this manner and in the process provide valuable information about their activities. But how much time do users spend on a given technology? Is the person being productive? Is the technology actually helping the user accomplish their tasks more efficiently? Measuring time allows it to be managed. More software applications are being created, but there is a need to capture and record the amount of time people spend using these applications. This will allow the user and technology owner to utilize time as a resource. Not only can time be used as a resource, but it can be measured and turned into a tangible reward. Once time is turned into a tangible reward, it can be traded as a commodity.

### SUMMARY

According to one exemplary embodiment, a method for recording time is disclosed. The method may include providing a software extension configured to monitor device activity, software activity, application activity, keyboard activity, and computer mouse activity. A user may register to use the extension and may create a log-in. When logged in, the user's activity may be monitored and reported to a database server. The user's time spent in the browser or video game may be given a redeemable value.

According to an alternative exemplary embodiment, a system for recording time may be disclosed. The system may include a browser or video game extension configured to monitor and report device activity, software activity, application activity, keyboard activity, and computer mouse activity. The system may also include a database server for storing reported activity information. There may further be redeemable vouchers rewarded to a user for time spent in the browser or video game.

### BRIEF DESCRIPTION OF THE DRAWINGS

Advantages of embodiments of the present invention will be apparent from the following detailed description of the exemplary embodiments. The following detailed description should be considered in conjunction with the accompanying figures in which:

FIG. 1 is a flow diagram of an exemplary method for recording time.

FIG. 2 is a flow diagram of an exemplary system for recording time.

FIG. 3 is an alternative flow diagram of an exemplary method for recording time.

FIG. 4 is an exemplary value chart for recorded time.

FIG. 5 is an exemplary system for recording time.

### DETAILED DESCRIPTION OF THE DRAWINGS

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage, or mode of operation.

Further, many of the embodiments described herein may be described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

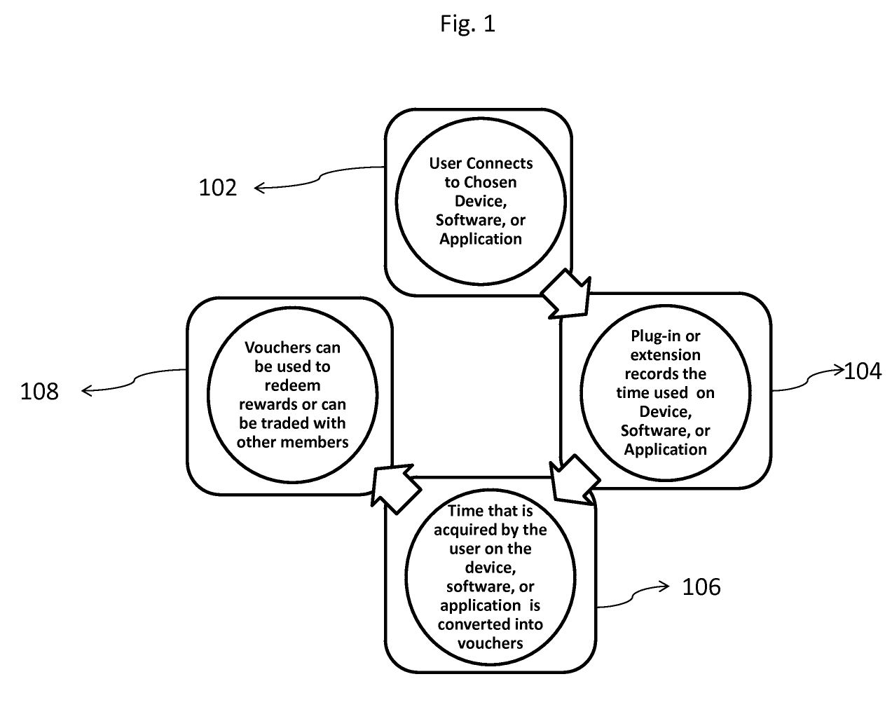

FIG. 1 is a flow diagram of an exemplary method for recording time. The time recorded may be for activity on a device, software, or application including, but not limited to, computers, tablets, cell phones, television, games, digital books, exercise apparatus, web browsers, mobile apps, and video games. The user may log-in to a plug-in or software extension incorporated with the device, software, or application 102. The plugin or extension may monitor the device, software, or application and may record the time the user has spent on the device, software, or application in an accounting database 104. The accounting database 104 may be a remote database configured to retain and provide access to user information or it may communicate data with such a remote database. In an exemplary embodiment, the extension may monitor through motion, keyboard input, mouse input or similar indications of user activity as would be reasonably understood by a person having ordinary skill in the art. In some embodiments, the device, software, or application may be configured to monitor, record, or communicate activity information, without the need for a plugin or extension. The recorded time may be exchanged for vouchers 106. Vouchers may be used to redeem rewards or may be traded with other members 108. Vouchers may represent monetary value, promotions, products, or services.

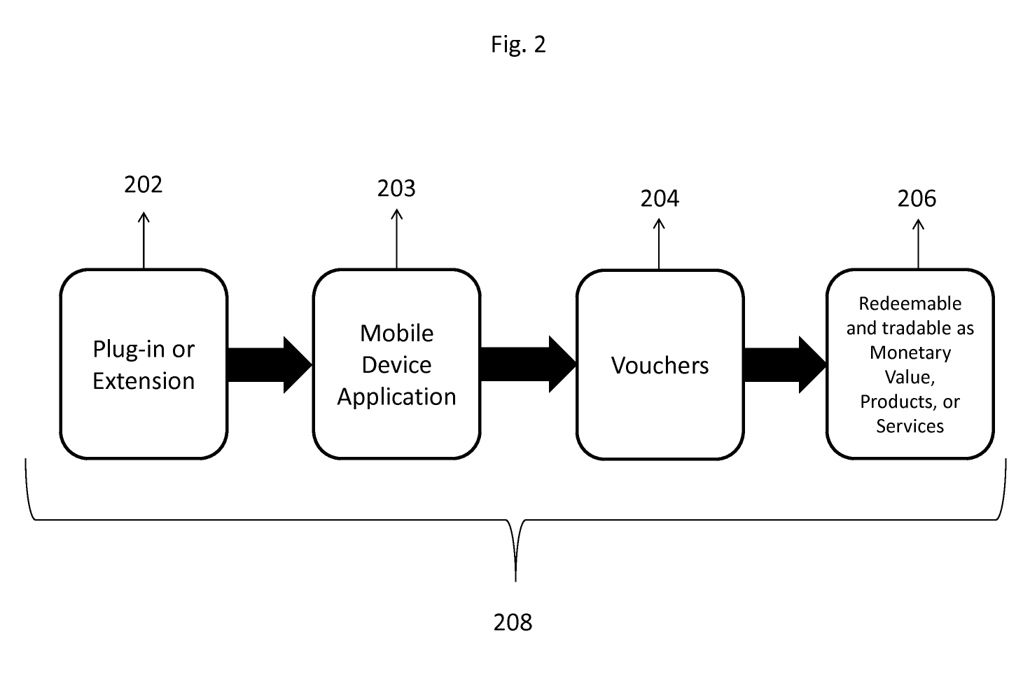

FIG. 2 is a flow diagram of an exemplary system for recording time. The system 208 may contain a device, software, or application plugin or extension 202. The plugin or extension 202 may operate to monitor and record activity. The recorded activity may include the time a user spends logged in to the plug-in or extension 202. Awards or vouchers may be generated based on the recorded activity. The extension 202 may include profile pages and may have a built-in marketplace for redeeming rewards or vouchers 204. Profile pages may be created by users and may be shared with other users. Business entities that have signed up as business users may also have profile pages. Similarly, in embodiments where the device, software, or application may be configured to monitor activity without the need for an extension 202, the same information may be recorded. In such embodiments, the profile pages and marketplace may be built in to a device, software, or application interface. The vouchers 204 may be used to redeem rewards 206 or trade with others in the community. In some alternative embodiments, a separate device application, such as a mobile device application 203 may monitor a user's activity on a device software or application. The application may record information from a plug-in, extension, software, or application and provide a marketplace for redeeming rewards or trading with others in the community.

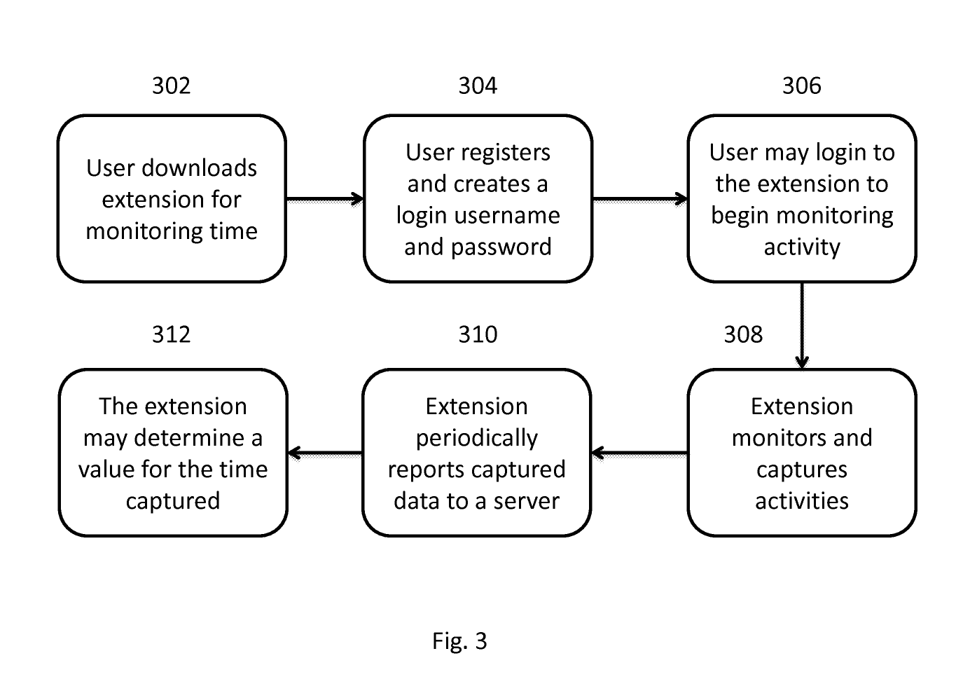

FIG. 3 is a flow diagram of an exemplary system and method for recording time spent on a device, software, or application. In an exemplary embodiment, a user may download an extension for monitoring time 302. Registration 304 may be required to use the extension. Registration may include agreeing to terms and conditions. A username, password and e-mail address may be needed to complete the registration process. If the e-mail address is already in use, the registration may be denied. Once the username, password and e-mail have been approved, registration may be complete and the user may login to the extension with the selected username and password. A registered user may subsequently view and update a member profile.

Still referring to FIG. 3, the user may log-in 306 to the extension to initiate monitoring the user's time spent on the device, application, or software. In this exemplary embodiment, the device, application, or software may be a web browser. Username and password information may be encrypted and stored in a cookie file. The extension may also “auto login” the user if the username and password information is stored and the user selects the “auto login” option. The login process occurs when the username and password are supplied, converted to binary (encrypted) and sent to a RESTful Service (RS). The RESTful Service may receive the binary string, decrypt it into two parts, the username and the password. The password may remain encrypted. The service may log into or access a database, such as an SQL database, to scan for a possible username and password match. If the username and password are a match, the user may be logged in. In an exemplary embodiment, a message may be displayed depending on the results of the username and password comparison. The message may read, “Authenticated!” if the query matches, and it may be sent to the extension. If there is a successful match, a token may be created and placed into a variable in the requester's context header. A variable may also be created with the string “Authenticated!” or AccessDenied” stored in it. In some embodiments, the user may have already logged in from the web browser, in which case a token may already exist for the extension. The token may be required to logout. A valid token may be supplied to log out and it may be removed from the database if valid.

Still referring to FIG. 3, an exemplary embodiment of the extension may monitor mouse and keyboard movement within the browser. In some embodiments, the extension may only monitor the currently opened tab. The extension may be active so long as the browser is open and is the current active page or tab. The extension may report back to a server on a periodic basis 310. In an exemplary embodiment, the periodic basis may be approximately every 10 seconds. The extension may report information on URL's the user views when it periodically reports. The extension may report other similar information about the activity of the user. If there is no activity by a user for a predetermined period of time, the extension may send a final transmission to the server and stop reporting activity. Once the browser becomes active again and input by the user is recognized, the monitoring and reporting process may start over.

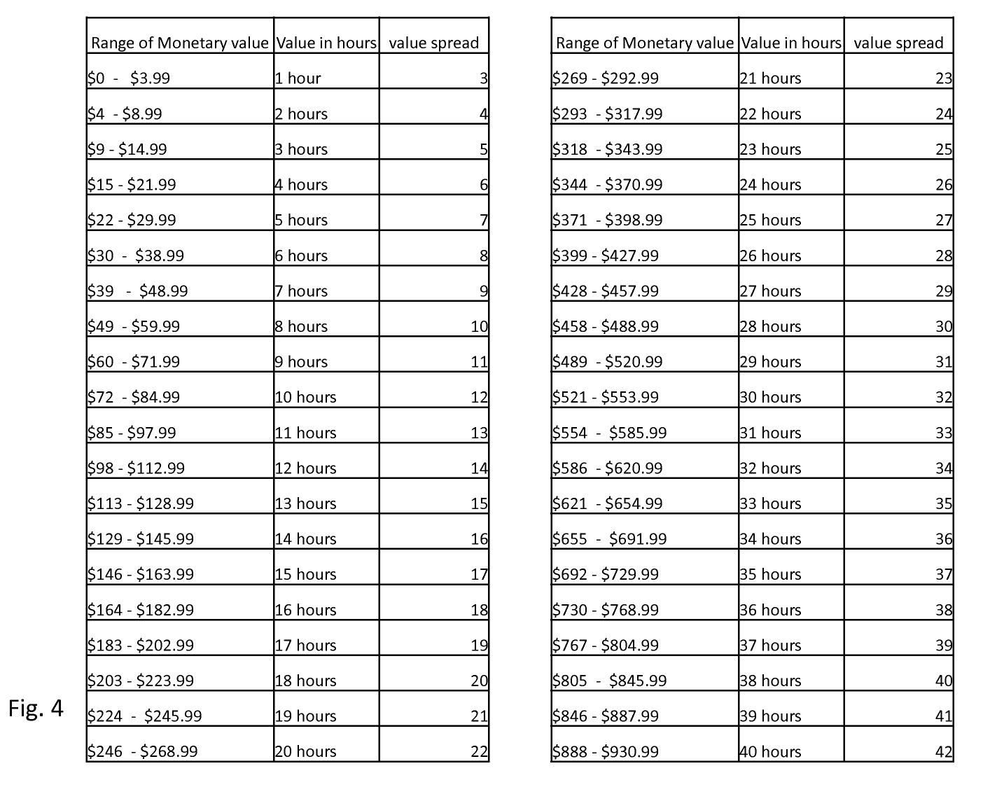

When logged in, the software extension may capture video game or browser activities, computer keyboard or mobile keyboard activities, and computer mouse activities 308. The duration of these activities may be stored in an account. In an exemplary embodiment, the duration may be measured in hours and minutes. A value may be generated based on the amount of time captured. The value may include money and its equivalents, products, or services and may be provided by businesses or individuals desiring to reward users. A value for time spent may be calculated with an algorithm 312. A chart showing an exemplary algorithm may be provided in FIG. 4. There may be a value range for each hour captured and the spread may increase by one increment with each successive hour. The software may be programed to exchange time captured for goods, services or monetary value.

The extension may translate time spent on the device, software, or application into purchasing power. This may be accomplished through assisting and enabling users to receive optimized value from their activities and to deliver purchasing incentives at the right time, at the right place, and for the right product or service. Purchasing incentives and targeted promotions and advertisements may be derived from activity information reported by the extension. The operator of the extension or the activity being monitored may use the information to generate the targeted promotions.

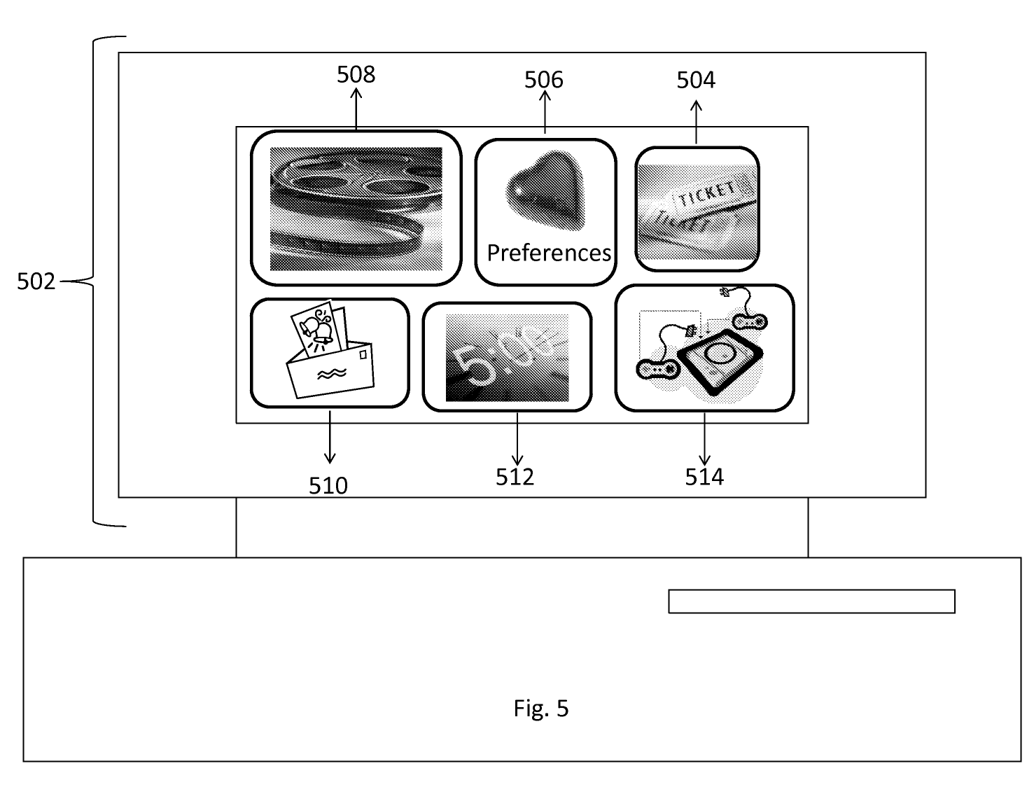

FIG. 5 is an exemplary system for recording time. System 502 may provide user features in addition to monitoring activity, generating vouchers, providing user profiles and providing a marketplace. The features of system 502 may be incorporated in embodiments as disclosed above. System 502 may allow users to post videos 508, increasing user time and activity. This may allow the user to share videos with other members of the community. The system 502 may have an option to store preferences or favorites 506. This feature may give users the choice of businesses or companies from which they may receive vouchers, coupons or advertisements. Favorite businesses selected by a user may be able to view the user's profile. A business may have to be a member of the virtual community to be selected as a favorite. The system 502 may include a trading post, marketplace, or voucher exchange 504. This feature may be added to the extension. It may provide a platform to sell or exchange goods or services for time earned by an interested trader. It also may provide a platform for users to buy or exchange goods or services with their earned time. For example, person A may want a shoe and person B may be offering a shoe in exchange for 3 hours. Person A may give 3 hours to person B and person B may, in return, give person A the shoe. In some embodiments, users may receive and manage their vouchers through the marketplace 504. The vouchers may be awarded for recorded time. The marketplace 504 may allow the user to trade the vouchers with other members of the community. Similarly, there may be a transfer platform that enables a user to transfer time earned to a different user. This may occur in a situation where person A needs 5 hours to get a particular deal, but person A only has 3 hours in the time bank. Person B may be able to transfer 2 hours to person A's account so that person A may get the deal.

Still referring to FIG. 5, the system 502 may allow the user to submit petitions or requests 510. This feature may give the user the opportunity to request that a business or a company join the virtual community. The system 502 may also have an accounting database 512, which may record how long the user has been using the device, application, software, or extension. This recording may determine how many vouchers the user receives. The system may also contain a link to video games 514.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for monitoring time comprising:
providing a software extension configured to monitor device activity, software activity, application activity, keyboard activity, and computer mouse activity;
allowing a user to register and log-in to the software extension;
monitoring a user's activity when the user is logged in to the extension;
measuring time spent on at least one of a device, software, or application from the monitored activity;
reporting activity and time data to a database server; and
allowing the user to log out.

2. The method of claim 1, further comprising providing vouchers to the user based on monitored activity time.

3. The method of claim 1, further comprising calculating a monetary value for the time measured.

4. The method of claim 1, further comprising providing a marketplace through the extension for redeeming products, services, or money for vouchers or for trading vouchers.

5. The method of claim 1, wherein the reporting of time spent on a device, software, or application stops when the user has been idle for a set period of time and resumes when user activity is detected.

6. The method of claim 1, wherein the device, software, or application comprises a web browser.

7. The method of claim 6, wherein activity data comprises URL data.

8. The method of claim 1, further comprising generating targeted promotions based on reported user activity data.

9. The method of claim 1, wherein the extension monitors time and activity and communicates with an application that records the information.

10. The method of claim 9, wherein the application provides a marketplace for redeeming rewards based on recorded user activity.

11. A system for monitoring time comprising:
a software extension configured to monitor and report device activity, software activity, application activity, keyboard activity, and computer mouse activity; and
a database server for storing reported activity information.

12. The system of claim 11, further comprising a computer application for recording monitored data from the software extension.

13. The system of claim 11, further comprising vouchers to represent time spent on at least one of a device, software, or application and to carry value.

14. The system of claim 13, wherein the application comprises a marketplace interface for redeeming the value of vouchers through products, services, money, or trade.

15. The system of claim 11, wherein the reported activity information is used to generate targeted promotions.

16. The system of claim 11, wherein the device, software, or application comprises a web browser.
